(19) United States
(12) Patent Application Publication
(10) Pub. No.: US 2012/0202380 A1
(43) Pub. Date: Aug. 9, 2012

(54) PLUG-IN CONNECTION HAVING SHIELDING

(75) Inventor: Juergen Lappoehn, Gammelshausen (DE)

(73) Assignee: ERNI ELECTRONICS GMBH, Adelberg (DE)

(21) Appl. No.: 13/394,622

(22) PCT Filed: Sep. 8, 2010
(86) PCT No.: PCT/DE10/01055

§ 371 Date: Mar. 29, 2012

(30) Foreign Application Priority Data
Sep. 8, 2009 (DE) 10 2009 040 487.2

(51) Int. Cl. H01R 13/648

(52) U.S. Cl. 439/607.09; 439/607.08

(57) ABSTRACT

The invention relates to a plug-in connection having shielding, in particular a multi-pin, multi-row plug-in connection comprising a male multipoint connector and a female multipoint connector, the plug-in connection comprising signal contacts, which are arranged in a contact pattern of differential pairs and which form a contact group together with an L-shaped shielding element that surrounds the signal contacts, the contact groups being arranged in rows and columns and adjacent contact groups in adjacent columns being offset from each other by a specifiable length dimension in the longitudinal direction of the columns, the plug-in connection being characterized in that the specified length dimension corresponds to approximately half the distance of two adjacent contact groups in a column.

The invention relates to a plug-in connection with shielding, especially a multi-pin, multi-row plug-in connection consisting of a male multipoint connector and a female multipoint connector, which respectively comprise signal contacts which are arranged in contact patterns of differential pairs and which form a contact group together with an L-shaped shielding element that surrounds said signal contacts, with the contact groups being arranged in rows and columns and adjacent contact groups in adjacent columns being offset from each other by a predeterminable length dimension in the longitudinal direction of the columns.

### DESCRIPTION OF THE PRIOR ART

A plug-in connection of this kind is disclosed by DE 603 16 145 T2 for example. In this plug-in connection, adjacent contact groups in adjacent columns are respectively arranged in an offset manner with respect to each other by a predeterminable length dimension in the longitudinal direction of the columns. The signal contacts are enclosed by an L-shaped shielding element which does not completely enclose the signal contacts however. For this reason, the L-shaped shielding elements are respectively arranged in an alternating fashion from column to column twisted by 180° with respect to each other. Furthermore, the signal contacts are arranged in this plug-in connector offset to one another in adjacent columns by a length dimension which substantially corresponds to the distance of the signal contacts in a contact group. This arrangement in conjunction with the L-shaped shielding elements that do not completely shield the signal contacts and their arrangement do not allow any disturbance-free signal transmission in the very high frequency range.

A plug-in connector with shielding is disclosed in US 2001/0046810 A1 and U.S. Pat. No. 6,328,602 B1, with which higher densities and higher speeds can be achieved in combination with simultaneously reduced electromagnetic coupling (crosstalk) between the signal contacts.

According to US 2001/0046810 A1, an electric connector is provided with insertion pieces with shielding in one piece, which pieces are oriented transversely to the shieldings in a second piece. One piece of the connector is made of wafers with shieldings which are positioned between the wafers. The shieldings in one piece have contact sections in order to produce an electrical connection with shieldings in the other piece. A connector is obtained in this way which can be produced easily and has improved shielding characteristics.

In the plug-in connector according to U.S. Pat. No. 6,328,602 B1, the signal contacts and ground contacts are arranged in an offset manner with respect to one another in adjacent columns in order to prevent crosstalk between the signal contacts. The shielding contacts comprise wing-like projections which partly enclose the signal contacts elements. Such an arrangement does not easily enable a densely packed arrangement of the signal and shielding contact elements. Moreover, the signal behavior is not optimal in such a connector.

A plug-in connection with shielding and signal contacts which are arranged in contact patterns of differential pairs and form a respective contact group together with an L-shaped shielding element enclosing the same, with the contact groups being arranged in rows and columns, is further known from EP 1 470 618 B1.

In the electronics industry, rectangular plug-in connections are frequently used for an electric connection between two circuit boards such as a so-called backplane and circuit boards fastened to the same, or also between circuit boards and connecting lines. A male multipoint connector is arranged on a first circuit board for example and a female multipoint connector adapted to the male multipoint connector on a further circuit board. Said further circuit board will then be fastened by means of the female multipoint connector of the plug-in connection to the first circuit board and will be electrically contacted.

The transmission frequency of electrical signals through these connectors can be very high. It is not only necessary to have a balanced impedance of the various contacts within the female multipoint connector and the male multipoint connector order to reduce signal delays and reflections, but also a shielding of the differential contacts. This is realized by an L-shaped shielding as is disclosed by EP 1 470 618 B1.

In order to achieve an optimal data transmission rate, EP 1 470 618 B1 provides a plug connector with signal contacts which are arranged in a contact pattern of differential pairs aligned in rows and columns, with each differential pair enclosing two of the signal contacts which are spaced from one another by a first distance. A ground shielding is connected with each of the differential pairs, with each ground shielding comprising a male multipoint section which extends along one side of the two signal contacts in their associated pair, and with each ground shielding comprising a leg section which extends along one end of an associated differential pair, and with adjacent of the differential pairs being spaced by a second distance which is larger than the first distance. One tip of the male multipoint section of each of the ground shieldings extends over an outer end of each of the signal contacts of its associated differential pair.

High data transmission rates can already be achieved by such a plug-in connection. As a result of the straight arrangement of the contact groups in rows and columns, further miniaturization is not easily possible. In particular, an increase in the data transmission rate is not easily possible. Furthermore, it has proven to be disadvantageous in such connectors that as a result of their filigree configuration they often do not have the required stability which enable the repeated plugging and detaching of the two plug-in elements of male multipoint connector and female multipoint connector in an easy fashion.

The invention is therefore based on the object of further developing a generic plug-in connection with shielding in such a way that it allows even higher data transmission rates on the one hand and simultaneously has a sturdy configuration which also allows repeated plugging and detaching of the plug-in connection.

### SUMMARY OF THE INVENTION

This object is achieved by a plug-in connection with shielding of the kind mentioned above in such a way that adjacent contact groups are arranged in adjacent columns offset from one another by a predeterminable length dimension, with the length dimension corresponding approximately to half the distance of two adjacent contact groups in a column. As a result, not only a maximally possible distance is achieved between the contact groups in one column and the contact groups in an adjacent column so that further miniaturization of the signal contacts can be achieved, but it is also possible by an enlargement of the distance of signal contacts arranged in adjacent columns to achieve a further increase in the data transmission rate to 25 gigabits per second or more. It is a further important advantage that as a result of this respectively offset arrangement of adjacent contact groups in adjacent columns intermediate spaces are produced between the contact groups which can be used on the one hand for arranging stabilizing elements in the plug housing and on the other hand also for improving the shielding between adjacent contact columns, as will be explained below in closer detail.

Further advantageous features and configurations and embodiments of the invention are the subject matter of the dependent claims. A highly advantageous embodiment provides that the predeterminable length dimension corresponds approximately to half the distance of two adjacent contact groups in a column. As a result, a maximally possible distance between the contact groups in a column and the contact groups in an adjacent column is achieved.

It is advantageously provided that the contact groups of the female multipoint connector which are arranged in a column are respectively arranged in a wafer. As a result, the plug can be produced by a layered configuration of such wafers in an especially advantageous manner. In order to achieve an optimal shielding effect it is provided that one respective shielding plate is arranged between adjacent wafers. As a result of the offset arrangement of the contact groups in adjacent contact columns it is now possible that contact elements of the shielding plates are arranged in an offset manner and contact with the shielding elements of adjacent contact groups is established thereby. It is advantageously provided in this connection that the shielding plates comprise a plurality of bent tapering contact springs on its sides facing the plug openings, which contact springs engage in recesses which are adjusted thereto and are arranged in adjacent wafers.

Such an arrangement is only enabled by the offset arrangement of the contact groups in adjacent columns. Only this ensures that even in the case of compact and further miniaturized configuration there will not be any contact between the pair of differential contacts and the contact springs of the shielding plates. As a result of the offset arrangement, the contact springs of the shielding plates are as far away as possible from the pairs of differential contacts. It is further advantageously provided for this purpose that the shielding plates are provided with a thinner configuration in the region of the bent tapering contact springs. This improves the spring effect on the one hand and takes the limited overall space into account on the other hand.

In order to enable maintaining a predetermined modular dimension on the plug side on the one hand and a smaller modular dimension on the circuit board side on the other hand where both the male multipoint connectors and also the female multipoint connectors are fixed and contacted by soldered connections or pressed connections or in any other way, an advantageous embodiment provides that the contact elements of the male multipoint connector taper in such a way that the distance of adjacent contact elements on the circuit board side are slightly smaller than the distance of the contact elements on the plug side.

The tapering is preferably realized by stamping the contact elements on the circuit board side. Such a production can also be realized within the scope of mass production.

An especially advantageous configuration provides that reinforcing ribs are arranged in the male multipoint connector housing in the region of the respectively offset contact groups in which a cavity is formed. As a result, such reinforcing ribs are respectively provided on both sides of the contact group columns, which reinforcing ribs are respectively offset by one column width to the left and the right. These reinforcing ribs enable a substantial increase in the stability of the especially sensitive male multipoint connector housing.

### BRIEF DESCRIPTION OF THE DRAWINGS

Further advantages and features of the invention are the subject matter of the description below and the illustration of embodiments in the drawings. Features can either be realized individually or in combination.

The drawings show as follows:

FIG. 1 shows a schematic isometric illustration of a female multipoint connector and a male multipoint connector of a plug-in connection in accordance with the invention;

FIG. 2 schematically shows the arrangement of respectively adjacent contact groups;

FIGS. 3a, 3b show an isometric exploded view under different angles of the configuration of a female multipoint connector in accordance with the invention;

FIG. 4 shows a wafer of a female multipoint connector;

FIG. 5 shows the “plug face” of a female multipoint connector;

FIG. 6 shows a schematic isometric view of a shielding plate of a female multipoint connector and a part of the female multipoint connector;

FIG. 7 shows the arrangement of the contact springs of the shielding plates in the mounted state in a female multipoint connector;

FIG. 8 shows an isometric view of a male multipoint connector, partly in an exploded view;

FIG. 9 shows the contacts of the pairs of differential contacts of the male multipoint connector;

FIG. 10 shows a top view of a male multipoint connector, and

FIG. 11 shows the arrangement (layout) of the pairs of differential contacts and the ground contacts of a male multi point connector in accordance with the invention.

### DETAILED DESCRIPTION OF THE PREFERRED EMBODIMENTS

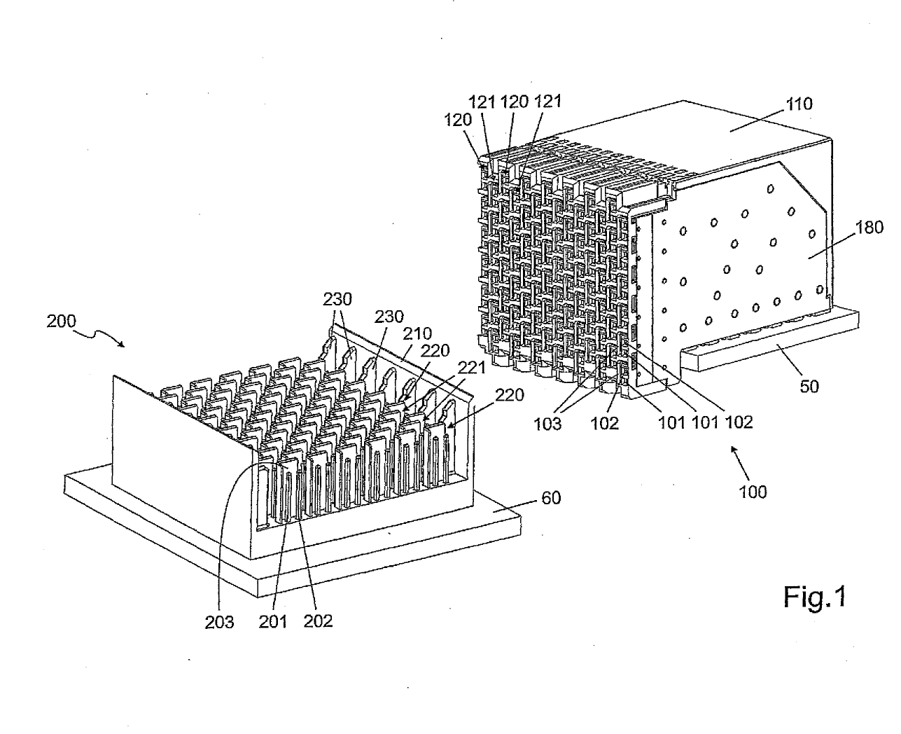

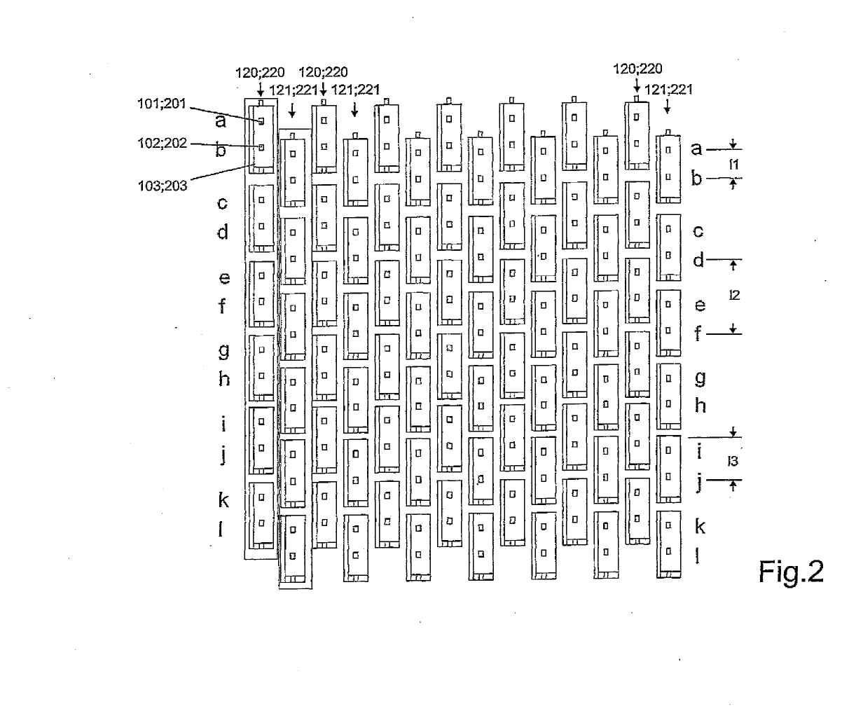

FIG. 1 shows a female multipoint connector 100 in the right half of the drawing, which female multipoint connector is fixed to and in contact with a circuit board 50 by means of soldered or pressed connections for example. The female multipoint connector comprises a plurality of contact group columns 120 on its front side, which columns are respectively arranged in parallel with respect to each other. Every contact group column 120 comprises a plurality of differential contact pairs 101, 102 which are arranged above one another and which are respectively enclosed by an L-shaped shielding plate 103. Two differential contacts 101, 102 and the associated shielding plate 103 respectively form one contact group. The plug therefore consists of a plurality of contact group columns and contact group rows, with the contact group rows being characterized in such a way that adjacent contact groups in an adjacent contact group column are respectively arranged in an offset manner by a predeterminable length dimension, as will be explained below in closer detail in conjunction with FIG. 2.

The male multipoint connector 200 also comprises contact group columns 220, with a further contact group column 221 being respectively arranged between two contact group columns 220, which contact group column is characterized in that the contact groups are respectively arranged in an offset manner by the same length dimension with respect to the contact groups of the adjacent contact group column 220.

FIG. 2 shows the respective contact group columns 120 and 220 as well as 121 and 221. The respective contact elements, i.e. contact springs 101 and 102 or contact pins 201 and 202, as well as the shielding elements, i.e. respective openings 103 and L-shaped shielding plates 203, are designated for reasons of simplicity from top to bottom in a continuous manner with the letters a), b), c), d) to I). As is shown in FIG. 2, the two differential contact elements 101, 102 and 201, 202 have a distance I1. Adjacent contact groups consisting of the differential contact pairs 101, 102 and 201, 202 and the shielding elements 103 and 203 have a distance I2. The contact groups are respectively arranged in an offset manner with respect to each other in such a way that each contact group in a contact group column 120, 220 respectively has a distance I3 in relation to an adjacent contact group in an adjacent column 121, 221. This distance I3 is preferably half the distance of adjacent contact groups in a column 120, 220 and 121, 221, i.e. I3=I2/2 applies. The largest possible distance between the differential contact pairs is formed in this manner. This arrangement is linked to the relevant advantages as described below.

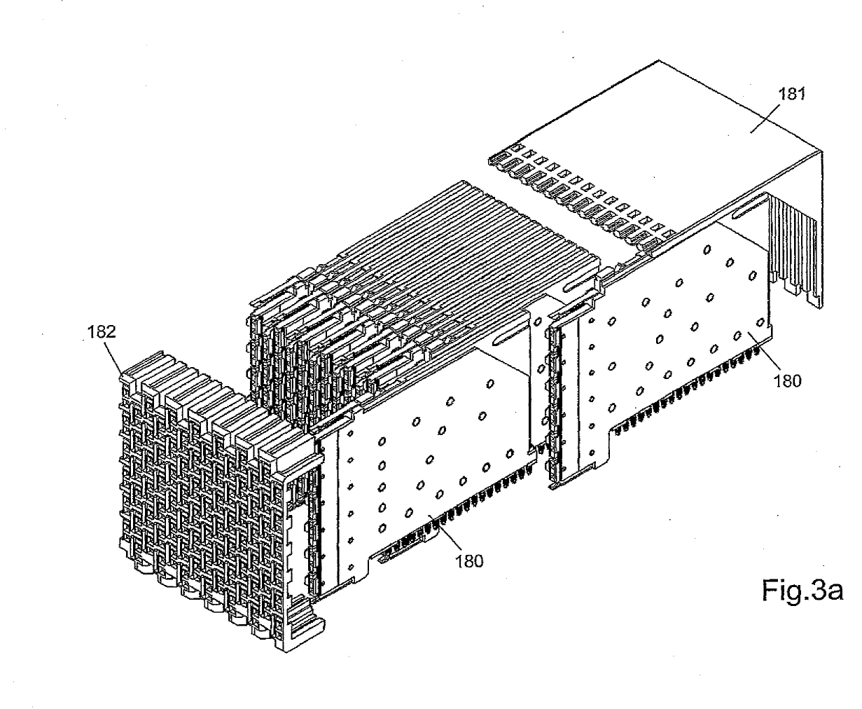

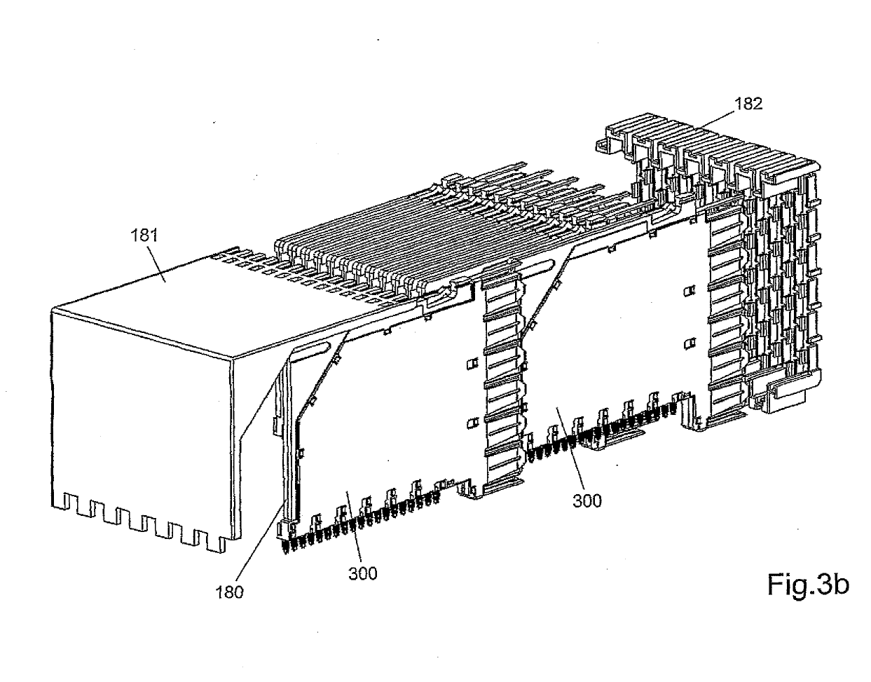

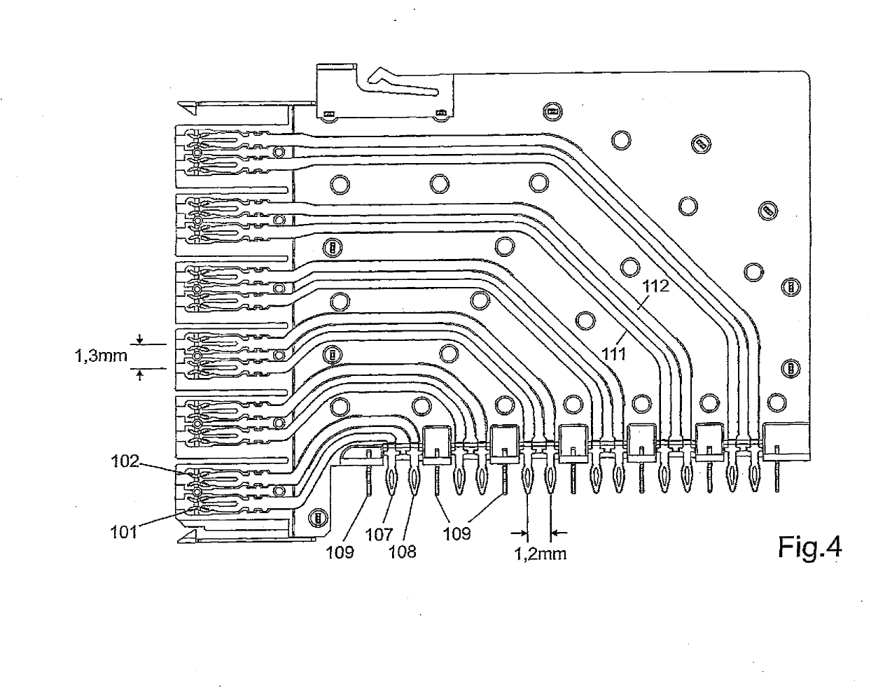

The configuration of a female multipoint connector is shown in FIGS. 3a, 3b and FIG. 4. Accordingly, the individual contact columns are part of a single wafer 180. The wafers 180 are arranged in a layered manner adjacent to one another, as is shown in FIG. 3a and FIG. 3b, with shielding plates 300 being arranged between the wafers 180, which will be discussed below in closer detail. The entire configuration will be fixed to a housing element 181 which is also used for stabilizing the female multipoint connector. A cover 182 with openings corresponding to the plug face is provided on the plug side. FIG. 4 shows a single wafer 180. The differential contact pairs 101, 102, which are arranged on the plug side, have a distance of 1.3 mm from one another for example. The differential contact pairs 101, 102 are connected with connection elements 107, 108 on the circuit board side by way of respectively angularly extending lines 191, 192 which extend in the wafer 180, as shown in FIG. 4. It is provided in this respect that the connection elements 107, 108 on the circuit board side have a slightly smaller distance from one another than the connection contacts on the plug side. The distance of the connection elements 107, 108 on the circuit board side is preferably 1.2 mm. Shielding contacts 109 are respectively provided between the signal contact elements 107, 108 on the circuit board side.

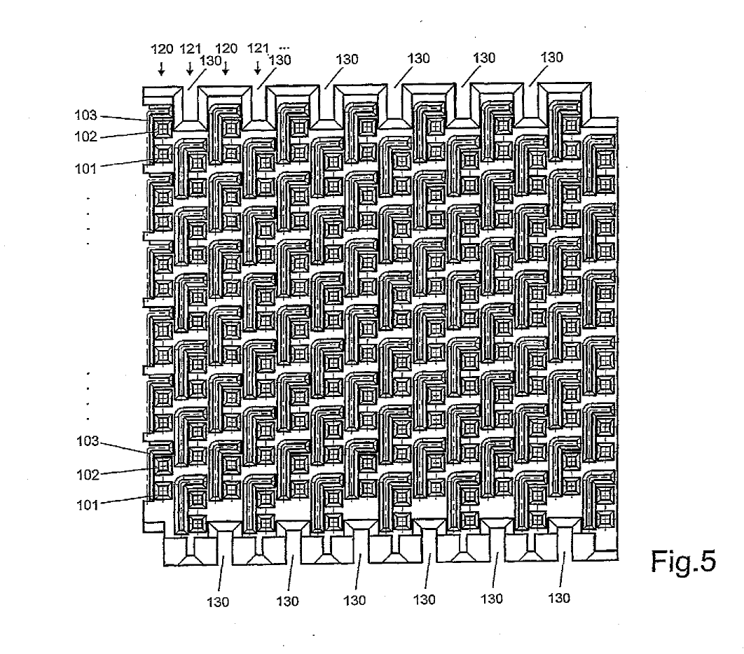

The so-called “plug face” is shown in FIG. 5, which shows the front cover 182 from the front. Contact groups consisting of signal elements 101, 102 which are enclosed by L-shaped shielding elements 103 follow in contact groups which are arranged in an offset manner in adjacent columns. This offset configuration leads to a respective cavity 130 between the adjacent columns, in which the reinforcing ribs 230 will engage which are arranged on the male multipoint connector 200. This substantially increases the stability of such a plug-in connection and especially allows repeated plug-in processes.

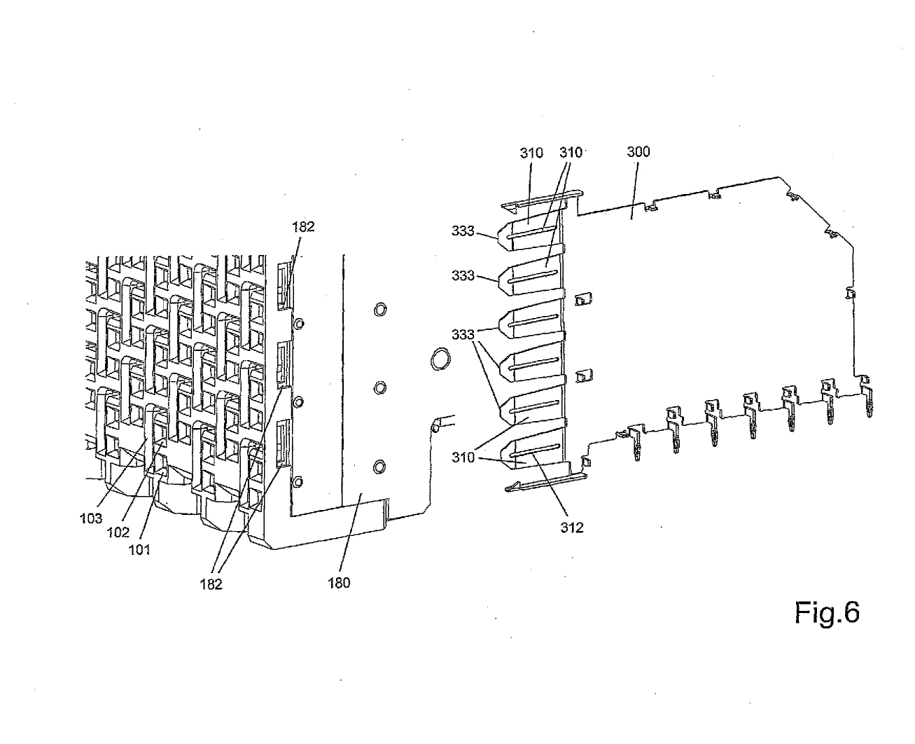

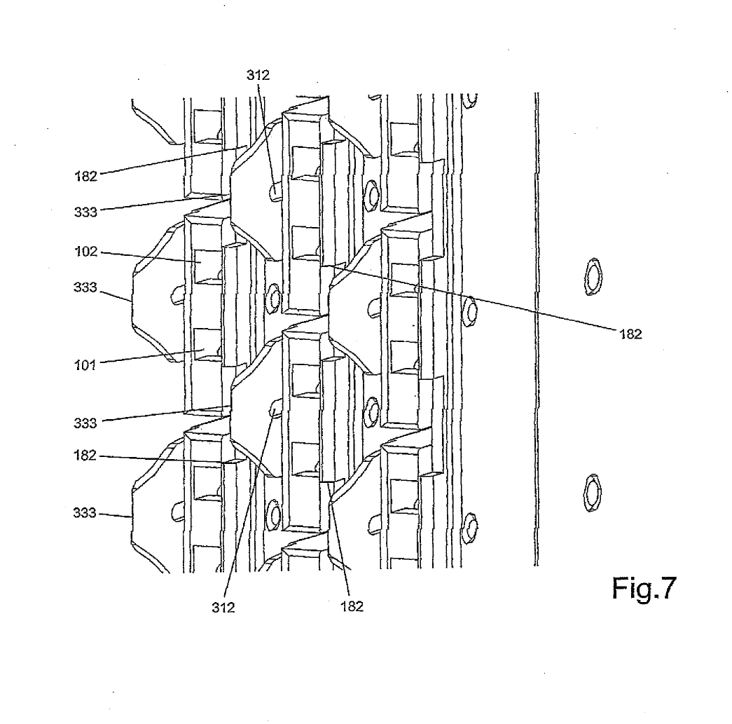

The shielding plates 300, which are arranged in a metallically conductive manner, comprise shielding contact springs 310 on their side facing the plug side, which contact springs respectively comprise a gap 312 for increasing the spring effect, as shown in FIG. 6 and FIG. 7. The shielding contact spring elements are curved in their front region and extend in a tapered manner to a point. The “tapered” configuration, i.e. the thinner configuration in the region of the tips 333, can be produced by stamping. The curved tips 333 engage into recesses 182 in the wafers 180 of the female multipoint connector, which recesses are adjusted to said tips. The recesses 182 are arranged in such a way (FIG. 6 and FIG. 7) that the curved tips 333 come to lie in a respectively offset manner in relation to the signal contact openings 101, 102 and come into electrical contact there with the respectively L-shaped shielding plates 203 in the inserted state of female multi point connector and male multipoint connector. As a result of the offset arrangement of the contact groups, the farthest possible distance between the shielding elements and the differential contact pairs is realized in this way and data transmission rates of 25 gigabits per second or more can only be achieved in this way.

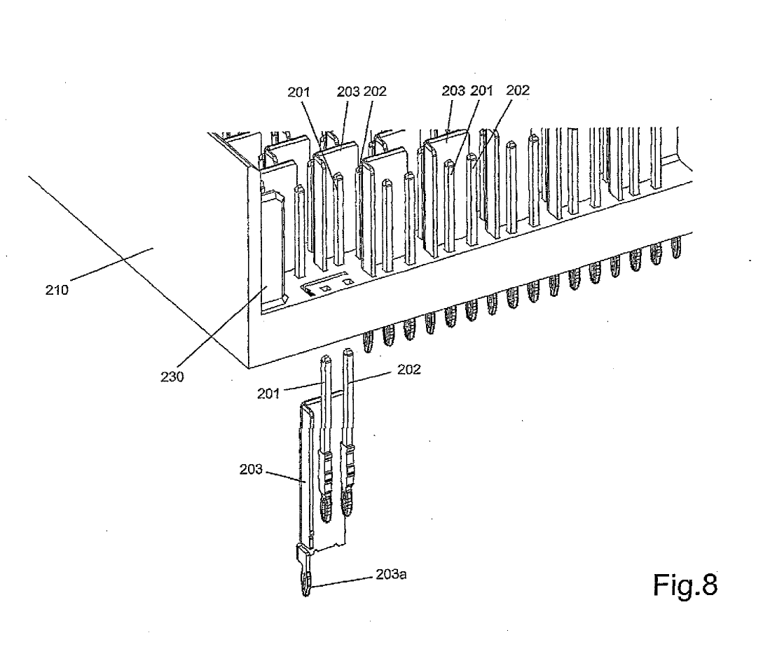

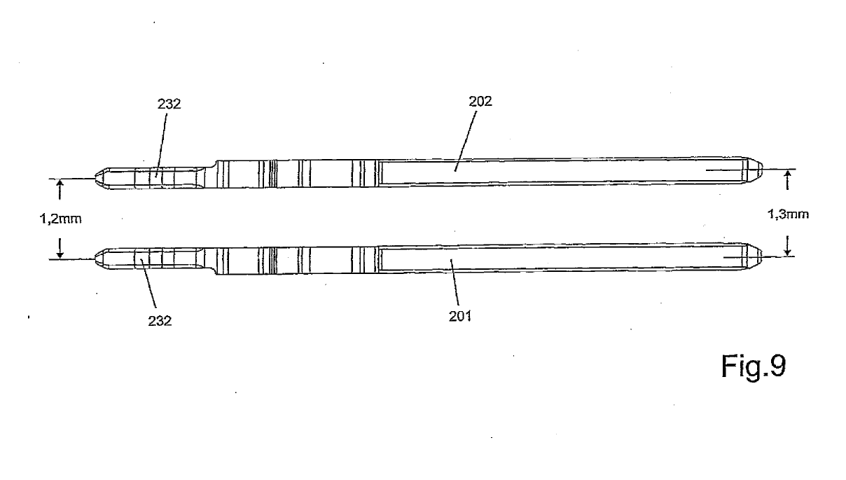

The configuration of the male multi point connector will briefly be explained below in connection with FIG. 8. The differential contact pairs 201, 202 and the L-shaped shielding elements 203 which enclose the former are arranged in the housing 210 of the male multipoint connector. It is provided that the differential contact elements have a larger distance of 1.3 mm for example on the plug side than on the circuit board side where the distance is 1.2 mm for example. This is realized in such a way that punched-off portions 232, 233 are provided on the contact elements 201, 202 (FIG. 9). A higher density of the contact elements on the circuit board is achieved thereby.

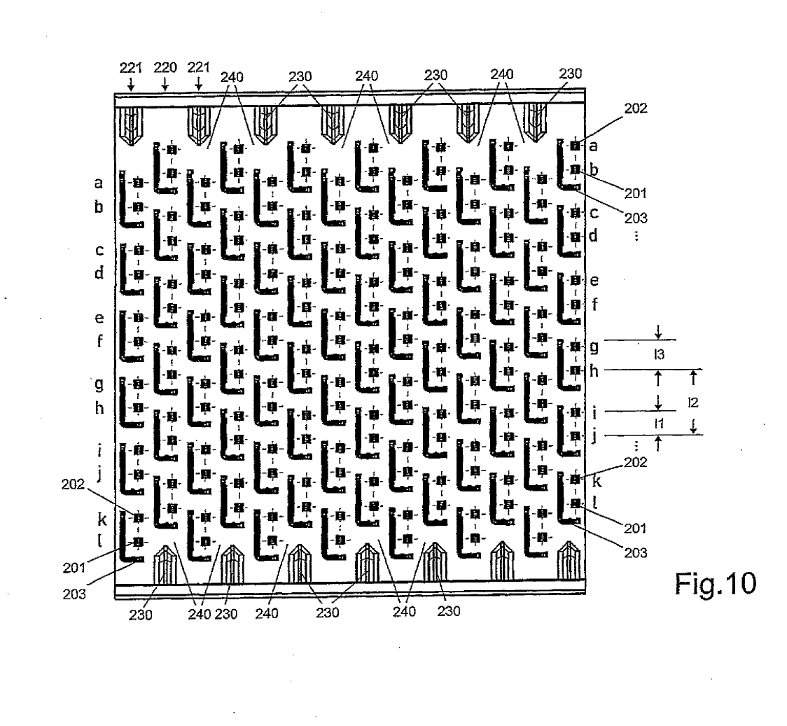

FIG. 10 shows the male multipoint connector in a top view. Differential contact pairs 201, 202 are respectively arranged in the housing 210, which differential contact pairs are enclosed by L-shaped shielding plates 203. The distance of adjacent differential contact elements 201, 202, which for the sake of simplicity are also designated in FIG. 10 in a continuous manner with letters a), b) . . . k), I), is I1 and the distance of adjacent contact groups in one column 220 and 221 is I2. The distance of adjacent contact groups of adjacent columns, i.e. the distance of each contact group in column 220 from an adjacent contact group in the column 221, is I3, with I3 substantially corresponding to I2/2, with I3=I2/2 therefore applying. In addition to an improved data transmission quality by further miniaturization, this offset arrangement also provides an increase in the stability in such a way that the reinforcing ribs 230 are respectively arranged in the male multipoint connector in the region of offset columns 221 and 220. As was already explained above, they engage into the cavities 130 of the female multipoint connector formed by offset arrangement as already explained above.

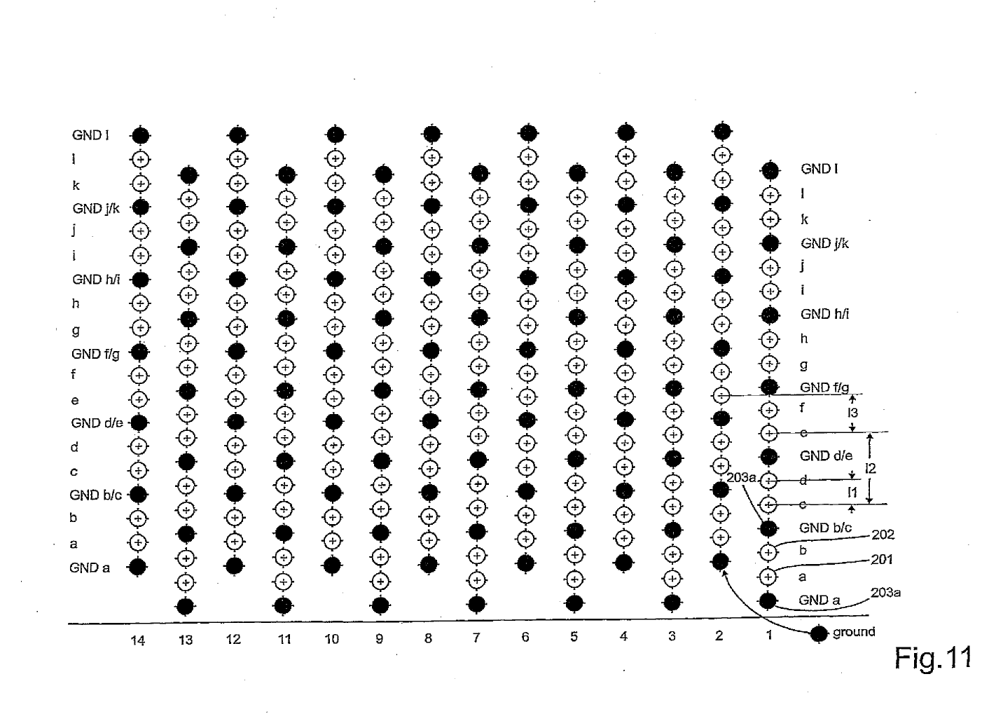

FIG. 11 shows the arrangement or the layout of differential contact pairs 201, 202 and the shielding contact elements 203a in a male multipoint connector. This illustration also shows that the distance of adjacent contact groups is I1 and adjacent columns, which are designated in FIG. 11 with continuing numbers 1 to 14, are respectively offset with respect each other by a distance I3, with I3=I2/2 applying. The distance I2 is the distance of adjacent contact groups in a column. FIG. 11 nicely shows the symmetry of the arrangement of differential contact pairs 201, 202 and shielding (ground) contact elements 203a (also see FIG. 8), which only allow the high signal transmission rates and especially the high signal transmission frequencies as confirmed by extensive tests by the applicant.

1. A plug-in connection with shielding, especially a multi-pin, multi-row plug-in connection consisting of a male multipoint connector and a female multipoint connector, having signal contacts which are arranged in contact patterns of differential pairs and which form a contact group together with an L-shaped shielding element that surrounds said signal contacts, with the contact groups being arranged in rows and columns and with adjacent contact groups in adjacent columns being offset from each other by a predeterminable length dimension (13), wherein the predetermined length dimension (13) corresponds to approximately half the distance (12) of two adjacent contact groups in a column.

2. A plug-in connection according to claim 1, wherein the contact groups of the female multipoint connector which are arranged in one column are respectively arranged in a wafer (180).

3. A plug-in connection according to claim 2, wherein one respective shielding plate (300) is arranged between adjacent wafers (180).

4. A plug-in connection according to claim 3, wherein the shielding plates (300) comprise on their sides facing the insertion openings a plurality of bent contact springs (333) which taper into a point and which engage into recesses (182) adjusted to the same in adjacent wafers (180).

5. A plug-in connection according to claim 4, wherein the shielding plates (300) are provided with a thinner configuration in the area of the bent tapering contact springs (333).

6. A plug-in connection according to claim 5, wherein the thinner region of the contact springs (333) can be produced by stamping.

7. A plug-in connection according to claim 1, wherein the contact elements (201, 202) of the male multipoint connector taper in such a way that the distance of adjacent contact elements (201, 202) on the circuit board side is slightly smaller than the distance of the contact elements (201, 202) on the plug side.

8. A plug-in connection according to claim 7, wherein the tapering can be realized by stamping of the contact elements (201, 202) on the circuit board side.

9. A plug-in connection according to claim 7, wherein reinforcing ribs (230) are arranged on the housing (210) of the male multipoint connector (200) in the region of the contact groups respectively arranged in an offset manner, which reinforcing ribs engage into cavities (130) of the female multipoint connector (100).
